(19) United States
(12) Patent Application Publication
(10) Pub. No.: US 2023/0297735 A1
(43) Pub. Date: Sep. 21, 2023

(54) APPARATUS AND METHOD OF GENERATING CONTEXT-CUSTOMIZED DIGITAL TWIN

(71) Applicant: ELECTRONICS AND TELECOMMUNICATIONS RESEARCH INSTITUTE, Daejeon (KR)

(72) Inventors: Ki-Sook CHUNG, Daejeon (KR); Ji Eun KIM, Daejeon (KR); Hyunjin KIM, Daejeon (KR); Seung Il MYUNG, Daejeon (KR); Mi Suk LEE, Daejeon (KR); Woo-Sug JUNG, Daejeon (KR)

(21) Appl. No.: 18/101,781

(22) Filed: Jan. 26, 2023

(30) Foreign Application Priority Data
Mar. 16, 2022 (KR) 10-2022-0032858

(51) Int. Cl. G06F 30/20

(52) U.S. Cl. CPC G06F 30/20

(57) ABSTRACT

A method of generating context-customized digital twin is provided. The method includes receiving pieces of basic data by using a data receiver, classifying the pieces of basic data into a plurality of layers and tagging the classified pieces of basic data to tags by using a preprocessor, generating context-customized digital twin models by using pieces of basic data corresponding to tags selected from among the tags by using a twin model generator, and storing the tags, the tagged pieces of basic data, and the context-customized digital twin models in a storage.

### CROSS-REFERENCE TO RELATED APPLICATION(S)

This application claims the benefit of the Korean Patent Application No. 10-2022-0032858 filed on Mar. 16, 2022, which is hereby incorporated by reference as if fully set forth herein.

### BACKGROUND

### 1. Field of the Invention

The present invention relates to an apparatus and method of generating context-customized digital twin, and more particularly, to data management for generating context-customized digital twin.

### 2. Description of Related Art

Digital twin is technology which analyzes various pieces of data collected from the real world in a virtual world implemented by copying the real world such as things, a space, and a process, derives an optimization scheme, and optimizes the real world, based thereon.

The digital twin is attracting much attention as technology which combines element technologies such as big data analysis, modeling, simulating, and network on the basis of a basic format such as an interconnection between the real world and the virtual world to solve various industrial and social problems in addition to manufacturing.

A maturity level of the digital twin is an evaluation criterion for understanding a realization level of the digital twin and may be defined as a first step of copying the real world to the virtual world, a second step of controlling the real world, and a third step of performing optimization on the real world.

A process of visualizing and monitoring information (data) obtained from the real world in the virtual world by using the digital twin needs many network resources and computing resources for performing analysis, prediction, and simulation, and due to this, is not activated in the field which needs to quickly solve a problem.

In a case where the digital twin is used in an emergency situation such as a disaster situation, because various experiments difficult to be executed in the real world may be reproduced in the virtual world, the digital twin is expected to be widely used in the field where a direct experiment is difficult. However, it is needed to improve a structure of a digital twin system, so as to use technology requiring a highly-advanced computing power like big data analysis and artificial intelligence along with real-time situation control.

### SUMMARY

An aspect of the present invention is directed to providing a data structure and a life cycle management system and method for context-customized digital twin, which may hierarchically define basic data needed for generating a digital twin model which is a virtual model of the real world, may apply a tagging technique to generate context or condition-customized digital twin, and may easily divide or recombine the context or condition-customized digital twin.

To achieve these and other advantages and in accordance with the purpose of the invention, as embodied and broadly described herein, there is provided an apparatus for generating context-customized digital twin, the apparatus including: a processor; a data receiver configured to receive pieces of basic data, based on control by the processor; a preprocessor configured to classify the pieces of basic data into a plurality of layers and tag the classified pieces of basic data to tags, based on control by the processor; a twin model generator configured to generate context-customized digital twin models by using pieces of basic data corresponding to tags selected from among the tags, based on control by the processor; and a storage configured to store the tags, the pieces of basic data tagged to the tags and the context-customized digital twin models, based on control by the processor.

In an embodiment, the classified pieces of basic data may include space data, sensing data, simulation data, dynamic data, and management data.

In an embodiment, the preprocessor may tag the classified pieces of basic data to tags by using a tagging matrix representing a mapping relationship between the pieces of basic data and attributes of each of the pieces of basic data.

In an embodiment, the preprocessor may tag the classified pieces of basic data to tags by using a tagging matrix which is configured with rows representing the pieces of basic data and columns representing attributes of each of the pieces of basic data.

In an embodiment, each of the tags may include a binary bit representing a mapping relationship between the classified pieces of basic data and attributes of each of the pieces of basic data.

In an embodiment, the apparatus may further include a twin model tagger configured to tag the context-customized digital twin model generated by the twin model generator.

In an embodiment, the twin model generator may divide or recombine pieces of basic data corresponding to the selected tags to reconfigure the context-customized digital twin models.

In another aspect of the present invention, there is provided a method of generating context-customized digital twin, the method including: receiving pieces of basic data by using a data receiver; classifying the pieces of basic data into a plurality of layers and tagging the classified pieces of basic data to tags by using a preprocessor; generating context-customized digital twin models by using pieces of basic data corresponding to tags selected from among the tags by using a twin model generator; and storing the tags, the tagged pieces of basic data, and the context-customized digital twin models in a storage.

In an embodiment, the pieces of basic data may be pieces of data for generating digital twins classified into the plurality of layers and may include space data, sensing data, simulation data, dynamic data, and management data.

In an embodiment, the tagging may include tagging the classified pieces of basic data to tags by using a tagging matrix representing a mapping relationship between the pieces of basic data and attributes of each of the pieces of basic data.

In an embodiment, the tagging may include tagging the classified pieces of basic data to tags by using a tagging matrix which is configured with rows representing the pieces of basic data and columns representing attributes of each of the pieces of basic data.

In an embodiment, each of the tags may include a binary bit representing a mapping relationship between the classified pieces of basic data and attributes of each of the pieces of basic data.

In an embodiment, the method may further include, after the generating of the context-customized digital twin models, tagging the context-customized digital twin model, generated by the twin model generator, to other tags by using a twin model tagger.

In an embodiment, the method may further include dividing and recombining the pieces of basic data used for generating the context-customized digital twin models corresponding to tags selected from among the other tags to generate updated context-customized digital twin models by using the twin model generator.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a diagram for describing a data management system for context-customized digital twin according to an embodiment of the present invention.

FIG. 2 is a diagram for describing a relationship between basic data classified into layers and customized digital twin capable of being generated based on the basic data classified into the layers, according to an embodiment of the present invention.

FIGS. 3A and 3B are diagrams for describing a tagging method according to an embodiment of the present invention.

FIG. 4 is a diagram for describing a system for managing a life cycle of basic data classified into layers, according to another embodiment of the present invention.

FIG. 5 is a diagram for describing a method of generating context-customized digital twin, according to an embodiment of the present invention.

FIG. 6 is a block diagram illustrating a computer system for implementing an apparatus and method of generating context-customized digital twin, according to an embodiment of the present invention.

### DETAILED DESCRIPTION OF THE INVENTION

In the following description, the technical terms are used only for explain a customized exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Hereinafter, example embodiments of the invention will be described in detail with reference to the accompanying drawings. In describing the invention, to facilitate the entire understanding of the invention, like numbers refer to like elements throughout the description of the figures, and a repetitive description on the same element is not provided.

First, the present invention relates to an apparatus and method, which may hierarchically define basic data needed for generating a digital twin model where the real world is expressed with digital, may apply a tagging technique to generate context or condition-customized digital twin, and may easily divide or recombine the context or condition-customized digital twin.

In the specification, to help understand the present invention, the disaster safety field will be described in an embodiment. The present invention is not limited to the disaster safety field and may solve various problems of the real world on the basis of digital twin to optimize the real world, and thus, the present invention may be applied to all corresponding fields.

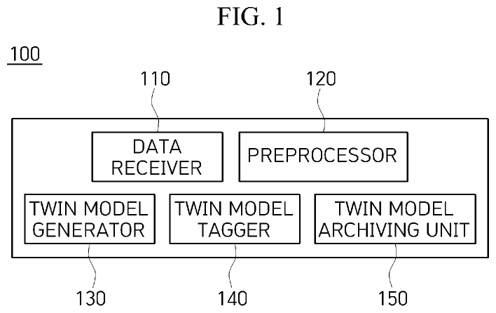

FIG. 1 is a diagram for describing an apparatus 100 for generating context-customized digital twin according to an embodiment of the present invention.

Referring to FIG. 1, the apparatus 100 for generating context-customized digital twin may include a data receiver 110, a preprocessor 120, a twin model generator 130, a twin model tagger 140, and a twin model archiving unit 150.

The data receiver 110 may receive various pieces of basic data, which are for generating context-customized digital twin, from an external device on the basis of a wired or wireless communication scheme. Here, the external device may be a sensor, an Internet of things (IoT) sensor, an on-line storage medium, and a server.

The preprocessor 120 may perform preprocessing on the pieces of basic data obtained by the data receiver 110. Here, the preprocessing may include a process of changing a data dimension of the pieces of basic data, a process of classifying the pieces of basic data into predefined layers, and a process of tagging the pieces of basic data, classified into the layers, to a tag(s) (hereinafter referred to as a first tag(s) or a hashtag.

A tag (value) may be used for identifying an attribute of each basic data, identifying a correlation with customized digital twin, and searching for pieces of basic data needed for generating customized digital twin having a user-desired level. The first tag(s) may be stored in a storage in a database form along with pieces of basic data.

The twin model generator 130 may generate a digital twin model corresponding to each layer by using the pieces of basic data classified into the layers. Here, various software engines such as an unreal engine and a unity engine may be used for generating the digital twin model. The present invention does not relate to a method of generating a digital twin model, and thus, a description thereof may be replaced with known technology.

Moreover, the twin model generator 130 may generate a digital twin model or a context-customized digital twin model, based on pieces of basic data corresponding to a selected first tag(s). For example, the twin model generator 130 may selectively read pieces of basic data, classified into a plurality of layers, from the storage (or a database) on the basis of the first tag(s) selected by a user, and then, may generate a digital twin model by using the read basic data or may selectively reconfigure the read basic data to generate a context-customized digital twin model having a user-desired level on the basis of the reconfigured basic data.

Moreover, the twin model generator 130 may combine the context-customized digital twin model or digital twin models tagged by the below-described twin model tagger 140 to generate a more improved context-customized digital twin model.

The twin model tagger 140 may perform a process of tagging the digital twin model (or the context-customized digital twin model), generated from the twin model generator 130, to a tag(s) (hereinafter referred to as a second tag(s)) and storing the second tag(s) in the storage.

The twin model generator 130 may read basic data of a digital twin model(s), corresponding to the second tag(s) selected by a user from among the second tags generated by the twin model tagger 140, from the storage, and then, may reconfigure the previously generated digital twin model (or the context-customized digital twin model) by using the read basic data.

The twin model archiving unit 150 may perform a process of storing the first tag generated by the preprocessor 120, the digital twin model or the context-customized digital twin model generated by the twin model generator 130, the second tag generated by the twin model generator 140, and basic data tagged by the first and second tags in a separate storage, for record analysis and statistic data performed later. Here, archiving may denote an operation of storing a desired record as a file in a storage medium during a specific period.

Furthermore, each of the preprocessor 120, the twin model generator 130, the twin model tagger 140, and the twin model archiving unit 150 may be implemented as a software module and/or a hardware module. In a case where each element is implemented as a software module, the elements 120 to 150 may be executed and controlled by a processor such as a central processing unit (CPU), a graphics processing unit (GPU), a microcontroller unit (MCU), or a system on chip (SoC).

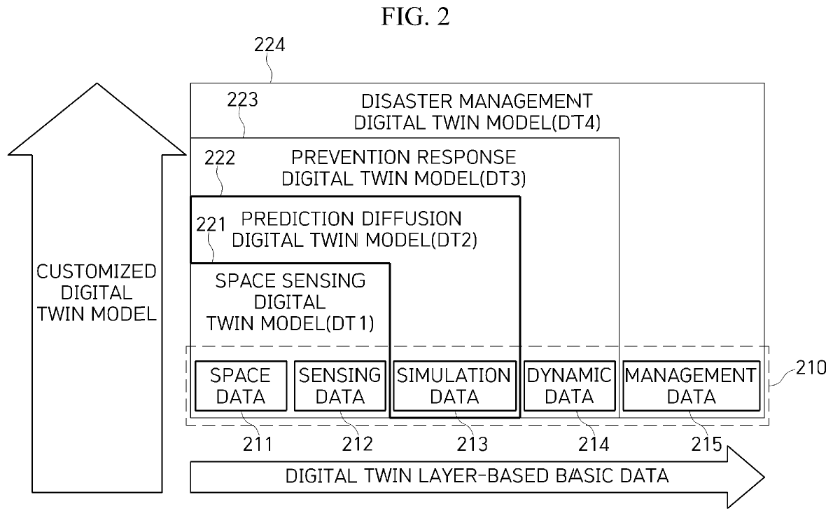

FIG. 2 is a diagram for describing a relationship between basic data classified into layers and customized digital twin capable of being generated based on the basic data classified into the layers, according to an embodiment of the present invention.

Referring to FIG. 2, basic data for generating digital twin may be classified into a plurality of layers on the basis of a maturity level of digital twin. Here, the maturity level of the digital twin may be defined as a first step of copying the real world (or a physical target) to the virtual world (or digital twin), a second step of controlling the real world on the basis of the virtual world, and a third step of performing optimization on the real world.

In a case which classifies basic data into five layers on the basis of the maturity level of the digital twin defined as the first to third steps, the basic data may be classified into space data 211, sensing data 212, simulation data 213, dynamic data 214, and management data 215.

The space data 211 may be data needed for two-dimensionally or three-dimensionally (2D or 3D) visualizing a physical space such as a building, a space, or a road having position coordinates.

The sensing data 212 may be data representing a context change of a space and may be various kinds of measurement data collected through a sensor such as a context awareness sensor or an environment sensor.

The simulation data 213 may be data which is used to predict a diffusion direction or a scale of a specific event on the basis of the space data 211 and the sensing data 212 when the specific event such as fire or flooding.

The dynamic data 214 may be data associated with a risk of the specific event and a user action, prevention, and response based on the risk and may be data associated with a dynamic service provided based on a position or a context of a patroller.

The management data 215 may be data associated with a response manual and a management manual for responding to a risk of the event.

A space sensing digital twin model 221 may be most basic digital twin which is obtained by intactly copying the real world and may be generated by using the space data 211 and the sensing data 212.

A prediction diffusion digital twin model 222 may be digital twin corresponding to an upper layer of the space sensing digital twin model 221 and may be generated by further using the simulation data 213 in addition to the space data 211 and the sensing data 212.

A prevention response digital twin model 223 may be digital twin corresponding to an upper layer of the prediction diffusion digital twin model 222 and may be generated by further using the dynamic data 214 in addition to the space data 211, the sensing data 212, and the simulation data 213.

A disaster management digital twin model 224 may be digital twin corresponding to an upper layer of the prevention response digital twin 223 and may be generated by further using the management data 215 in addition to the space data 211, the sensing data 212, the simulation data 213, and the dynamic data 214. In the present invention, the disaster management digital twin 224 may be referred to as event management digital twin.

In FIG. 2, an example is illustrated where the space data 211 and the sensing data 212 for generating the space sensing digital twin model 221 is classified into a bottom layer, the management data 215 for generating the disaster management digital twin 224 is classified into a top layer, and the simulation data 213 for generating the prediction diffusion digital twin model 222 between the bottom layer and the top layer and the dynamic data 214 for generating the prevention response digital twin 223 are classified into middle layers.

An order in which pieces of basic data are classified may be variously changed, and when desired basic data is selected and classified depending on the case, digital twins based on various combinations of total 31 kinds may be generated.

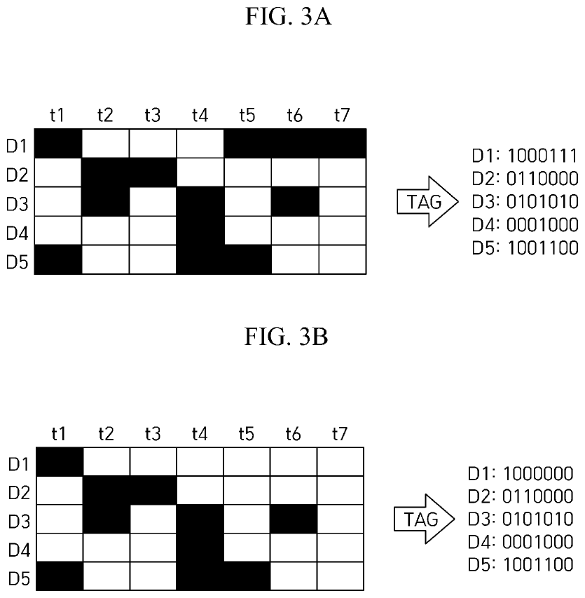

FIGS. 3A and 3B are diagrams for describing a tagging method according to an embodiment of the present invention.

First, referring to FIG. 3A, the preprocessor 120 may tag pieces of basic data D1 to D5 to the first tag(s) by using a matrix (hereinafter referred to as a tagging matrix) representing a mapping relationship between the pieces of basic data D1 to D5 and attributes t1 to t7 of the pieces of basic data D1 to D5. Here, the tagging matrix may be configured with rows representing the pieces of basic data D1 to D5 and columns representing the attributes t1 to t7 of the pieces of basic data D1 to D5.

In a case which generates a digital twin model where a space is expressed with digital, based on space data D1, a row of the tagging matrix may be configured with the pieces of basic data D1 to D5, and a column of the tagging matrix may be configured with attributes of the space data D1. In this case, the attributes of the space data D1 may be different zones t1 to t7.

When the space data D1 211 includes space data of a zone 1 t1, a zone 5 t5, a zone 6 t6, and a zone 7 t7, the space data D1 211 may be tagged to binary bits ‘1000111’ where each of a first bit (a most significant bit (MSB)), a fifth bit, a sixth bit, and a seventh bit (a least significant bit (LSB)) of seven bits is 1 and each of the other second bit, third bit, and fourth bit is 0.

When the sensing data D2 212 includes sensing data of a zone 2 t2 and a zone 3 t3, the sensing data D2 212 may be tagged to binary bits ‘0110000’ where each of a second bit and a third bit is 1, and each of the other bits is 0.

In this manner, when the simulation data D3 includes data associated with the zone 2 t2, the zone 4 t4, and the zone 6 t6, the simulation data D3 may be tagged to binary bits ‘0101010’.

As a result, the tagging method according to an embodiment of the present invention may denote that a mapping relationship between the pieces of basic data D1 to D5 and the attributes t1 to t7 of each of the pieces of basic data D1 to D5 in the tagging matrix is represented by a binary bit.

In FIG. 3B, digital twin divided into portions corresponding to t1 of D1 is illustrated. In this case, basic data of each layer may be reconfigured by extracting data mapped to D1 and t1.

A reconfigured digital twin model may be tagged to a second tag described above and may be stored in a storage. In this case, a row of a tagging matrix may be configured with digital twin models 221 to 224, and a column of the tagging matrix may be configured with the pieces of basic data D1 to D5. Digital twin where the user thereof ends may be archived and may be stored in in a separate storage, for record analysis and statistic data performed later.

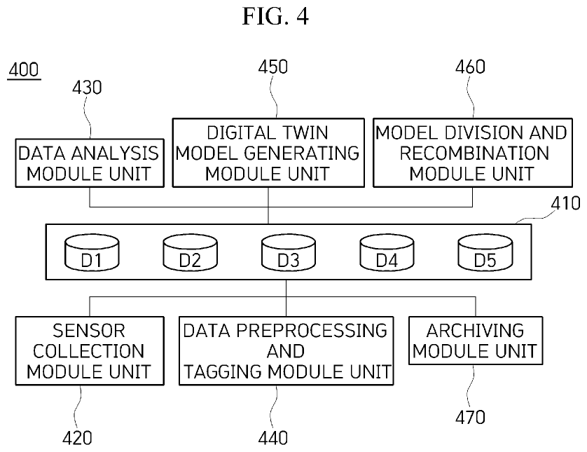

FIG. 4 is a diagram for describing a system for managing a life cycle of basic data classified into layers, according to another embodiment of the present invention.

Referring to FIG. 4, a life cycle management system 400 according to another embodiment of the present invention may include a storage 401 storing pieces of basic data D1 to D5 classified into layers, a sensor collection module unit 420, a data analysis module unit 430, a data preprocessing and tagging module unit 440, a digital twin model generating module unit 450, a model division and recombination module unit 460, and an archiving module unit 470.

The sensor collection module unit 420 may collect the pieces of basic data D1 to D5.

The data analysis module 430 may analyze basic data transferred from the sensor collection module unit 420 to classify the basic data into predefined layers.

The tagging module 440 may tag pieces of basic data, classified into layers by the data analysis module 430, to a first tag by using the tagging matrix described above with reference to FIGS. 3A and 3B and may tag a digital twin model to a second tag.

The digital twin model generating module 450 may generate a digital twin model by using the basic data classified into the layers, or may generate a context-customized digital twin model by using basic data corresponding to a selected first tag and/or second tag.

The model division and recombination module 460 may divide and recombine the basic data corresponding to the first tag and/or the second tag and/or previously generated digital twin models to generate a context-customized digital twin model.

The archiving module 470 may archive a digital twin model where the use thereof ends and may be stored in in a separate storage, for record analysis and statistic data performed later.

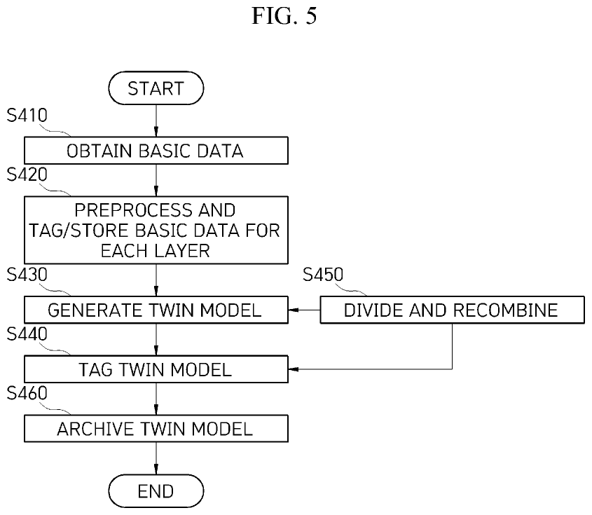

FIG. 5 is a diagram for describing a method of generating context-customized digital twin, according to an embodiment of the present invention.

Referring to FIG. 5, first, pieces of basic data may be obtained through a sensor in step S410. Here, as described above with reference to FIG. 2, the pieces of basic data may be pieces of data needed for generating digital twins classified into layers defined based on a maturity level of digital twin and may include space data D1 211, sensing data D2 212, simulation data D3 213, dynamic data D4 214, and management data D5 215.

Subsequently, a process of classifying the pieces of basic data into a plurality of layers and tagging the classified pieces of basic data to tags by using the preprocessor 120 may be performed in step S420. The tagging method may be performed by using a tagging matrix representing a mapping relationship between the pieces of basic data and attributes of the pieces of basic data D1 to D5. Here, as illustrated in FIGS. 3A and 3B, the tagging matrix may be configured with rows representing the pieces of basic data D1 to D5 and columns representing the attributes t1 to t7 of the pieces of basic data D1 to D5. In this case, tags tagged to the classified pieces of basic data may include a binary bit representing a mapping relationship between the classified pieces of basic data and attributes of each basic data. Also, the preprocessor may perform a preprocessing process of reducing a data dimension of each of the classified pieces of basic data prior to a tagging process. In this case, the tagging process may denote a process of tagging pieces of basic data where a data dimension is reduced.

Subsequently, a process of generating the digital twin models 221 to 224 corresponding to all layers on the basis of all pieces of basic data corresponding to the tags by using the twin model generator 130 or generating context-customized digital twin models by using pieces of basic data corresponding to some tags selected from among the tags may be performed in step S430.

Subsequently, a process of tagging a generated digital twin model or context-customized digital twin model to a tag by using the twin model tagger 140 may be performed in step S440. That is, in the present invention, the digital twin model or the context-customized digital twin model may be tagged. Here, the digital twin model or the context-customized digital twin model may be divided or recombined in step S450. A new twin model may be generated through division and/or recombination, and another tagging may be performed. Here, division and recombination may be construed as a process of designating a digital twin model or a context-customized digital twin model which is to be divided or recombined, based on selected tags, and dividing pieces of basic data associated with the designated digital twin model or context-customized digital twin model or recombining the divided pieces of basic data. The twin model generator 130 may generate a digital twin model or a context-customized digital twin model updated based on a divided and/or recombined model (pieces of basic data). When the updated digital twin model or the updated context-customized digital twin model is re-generated through division and/or recombination, a process of archiving a twin model where a life cycle of each basic data ends may be performed in step S460.

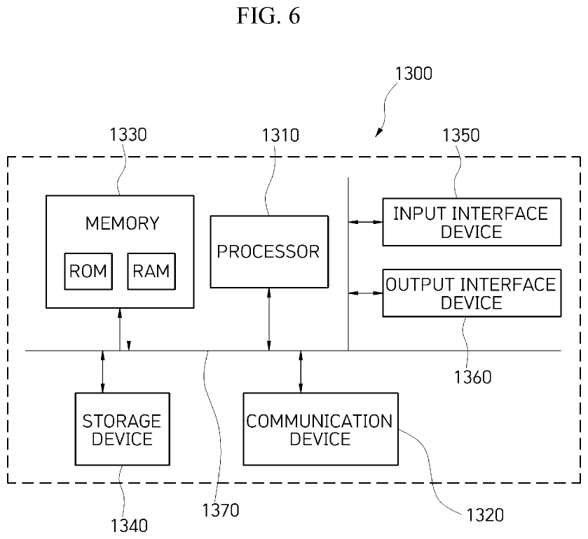

FIG. 6 is a block diagram illustrating a computer system 1300 for implementing an apparatus and method of generating context-customized digital twin, according to an embodiment of the present invention.

Referring to FIG. 6, the computer system 1300 may include at least one of a processor 1310, a memory 1330, an input interface device 1350, an output interface device 1360, and a storage device 1340 which communicate with one another through a bus 1370.

The computer system 1300 may include a communication device 1320 connected to a network. The processor 1310 may be at least one central processing unit (CPU) and/or at least one graphics processing unit (GPU), or may be a semiconductor device which executes an instruction stored in the memory 1330 or the storage device 1340.

The memory 1330 and the storage device 1340 may include various types of volatile or non-volatile storage mediums. For example, the memory 1330 may include read only memory (ROM) and random access memory (RAM).

In an embodiment of the present invention, the memory 1330 may be provided in or outside the processor and may be connected to the processor through various means known to those skilled in the art. The memory may be various types of volatile or non-volatile storage mediums, and for example, may include ROM or RAM.

Therefore, an embodiment of the present invention may be a method implemented in a computer, or may be implemented as a non-transitory computer-readable medium storing a computer-executable instruction. In an embodiment, when executed by the processor, the computer-readable instruction may perform a method according at least one aspect of the present invention.

The communication device 1320 may transmit or receive a wired signal or a wireless signal.

Moreover, the method according to an embodiment of the present invention may be implemented as a program instruction type capable of being performed by various computer means and may be stored in a computer-readable recording medium.

The computer-readable recording medium may include a program instruction, a data file, or a data structure, or a combination thereof. The program instruction recorded in the computer-readable recording medium may be specially designed for an embodiment of the present invention, or may be known to those skilled in the computer software art and may be used. The computer-readable recording medium may store may include a hardware device which stores and executes the program instruction. For example, the computer-readable recording medium may be a magnetic media such as a hard disk, a floppy disk, and a magnetic tape, an optical media such as CD-ROM or DVD, a magneto-optical media such as a floptical disk, ROM, RAM, or flash memory. The program instruction may include a high-level language code executable by a computer such as an interpreter, in addition to a machine language code such as being generated by a compiler.

According to the embodiments of the present invention, basic data needed for generating a digital twin model which is a virtual model of the real world may be classified into a plurality of layers, and context or condition-customized digital twin may be generated from the classified basic data by using the tagging technique and may be easily divided or recombined.

Moreover, in a case where a digital twin model is generated by using basic data classified into a plurality of layers, in addition to advanced digital twin generated based on all data for optimization of the real world, various context-customized digital twins may be generated from lightened digital twin corresponding to a bottom layer on the basis of contexts.

Moreover, a method may be provided where a correlation between layers is displayed by tagging the classified data in a process of classing basic data for generating digital twin into layers and preprocessing the classified basic data, and moreover, the generated digital twin may be divided or recombined.

Moreover, a tagging matrix for checking the range and attribute of digital twin at a time by tagging the digital twin may be provided, and thus, analysis and search may be easily performed, thereby increasing the use of digital twin.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for generating context-customized digital twin, the apparatus comprising:
a processor;
a data receiver configured to receive pieces of basic data, based on control by the processor;
a preprocessor configured to classify the pieces of basic data into a plurality of layers and tag the classified pieces of basic data to tags, based on control by the processor;
a twin model generator configured to generate context-customized digital twin models by using pieces of basic data corresponding to tags selected from among the tags, based on control by the processor; and
a storage configured to store the tags, the pieces of basic data tagged to the tags and the context-customized digital twin models, based on control by the processor.

2. The apparatus of claim 1, wherein the classified pieces of basic data comprise space data, sensing data, simulation data, dynamic data, and management data.

3. The apparatus of claim 1, wherein the preprocessor tags the classified pieces of basic data to tags by using a tagging matrix representing a mapping relationship between the pieces of basic data and attributes of each of the pieces of basic data.

4. The apparatus of claim 1, wherein the preprocessor tags the classified pieces of basic data to tags by using a tagging matrix which is configured with rows representing the pieces of basic data and columns representing attributes of each of the pieces of basic data.

5. The apparatus of claim 1, wherein each of the tags comprises a binary bit representing a mapping relationship between the classified pieces of basic data and attributes of each of the pieces of basic data.

6. The apparatus of claim 1, further comprising a twin model tagger configured to tag the context-customized digital twin model generated by the twin model generator.

7. The apparatus of claim 1, wherein the twin model generator divides or recombines pieces of basic data corresponding to the selected tags to reconfigure the context-customized digital twin models.

8. A method of generating context-customized digital twin, the method comprising:
receiving pieces of basic data by using a data receiver;
classifying the pieces of basic data into a plurality of layers and tagging the classified pieces of basic data to tags by using a preprocessor;
generating context-customized digital twin models by using pieces of basic data corresponding to tags selected from among the tags by using a twin model generator; and
storing the tags, the tagged pieces of basic data, and the context-customized digital twin models in a storage.

9. The method of claim 8, wherein the pieces of basic data are pieces of data for generating digital twins classified into the plurality of layers and comprise space data, sensing data, simulation data, dynamic data, and management data.

10. The method of claim 8, wherein the tagging comprises tagging the classified pieces of basic data to tags by using a tagging matrix representing a mapping relationship between the pieces of basic data and attributes of each of the pieces of basic data.

11. The method of claim 8, wherein the tagging comprises tagging the classified pieces of basic data to tags by using a tagging matrix which is configured with rows representing the pieces of basic data and columns representing attributes of each of the pieces of basic data.

12. The method of claim 8, wherein each of the tags comprises a binary bit representing a mapping relationship between the classified pieces of basic data and attributes of each of the pieces of basic data.

13. The method of claim 8, further comprising, after the generating of the context-customized digital twin models, tagging the context-customized digital twin model, generated by the twin model generator, to other tags by using a twin model tagger.

14. The method of claim 13, further comprising dividing and recombining the pieces of basic data used for generating the context-customized digital twin models corresponding to tags selected from among the other tags to generate updated context-customized digital twin models by using the twin model generator.
